(19) United States
(12) Patent Application Publication
(10) Pub. No.: US 2026/0245156 A1
(43) Pub. Date: Aug. 20, 2026

(54) METHODS, SYSTEMS, APPARATUSES, AND DEVICES FOR PERSONALIZING MENUS OF RESTAURANTS BASED ON A SUSCEPTIBILITY OF USERS TO ALLERGENS

(71) Applicant: Konstantin Vishnikin, Pine Bush, NY (US)

(72) Inventor: Konstantin Vishnikin, Pine Bush, NY (US)

(21) Appl. No.: 18/835,718

(22) PCT Filed: Jun. 6, 2023
(86) PCT No.: PCT/US2023/024522

§ 371 Date: Aug. 3, 2024

(51) Int. Cl. G06Q 50/12

(52) U.S. Cl. CPC G06Q 50/12

(57) ABSTRACT

Disclosed herein is a method for personalizing menus of restaurants based on a susceptibility of users to allergens. Accordingly, the method may include receiving a request from a user device associated with a user, retrieving user data associated with the user, retrieving a dish data of a dish associated with a restaurant based on the request, analyzing the user data and the dish data using a machine learning model, determining a presence of at least one allergen associated with the user in the dish based on the analyzing, determining a removability of the at least one allergen from the dish, generating a label for each of the dish, generating a menu for the user based on the label and each of the dish data of each of the dish, and transmitting the menu to the user device.

### FIELD OF THE INVENTION

Generally, the present disclosure relates to the field of data processing. More specifically, the present disclosure relates to methods, systems, apparatuses, and devices for personalizing menus of restaurants based on a susceptibility of users to allergens.

### BACKGROUND OF THE INVENTION

The field of data processing is technologically important to several industries, business organizations, and/or individuals. In particular, the use of data processing is prevalent for personalizing menus of restaurants.

Existing techniques for personalizing menus of restaurants are deficient with regard to several aspects. Further, current technologies do not facilitate personalizing menus of restaurants based on allergens present in the dish. The allergens are at least one ingredient of the dish that may cause allergic reactions in some users. Furthermore, current technologies do not facilitate using badges or indicators for indicating the presence of allergens in the dish and if they can be removed or not. Moreover, current technologies do not provide guests with important information about the ingredients in each dish.

Therefore, there is a need for improved methods, systems, apparatuses, and devices for personalizing menus of restaurants based on a susceptibility of users to allergens that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for personalizing menus of restaurants based on a susceptibility of users to allergens, in accordance with some embodiments. Accordingly, the method may include receiving, using a communication device, at least one request from at least one user device associated with at least one user. Further, the method may include retrieving, using a storage device, at least one user data associated with the at least one user based on the at least one request. Further, the method may include retrieving, using the storage device, at least one dish data of at least one dish associated with at least one restaurant based on the at least one request. Further, the at least one restaurant serves the at least one dish. Further, the method may include analyzing, using a processing device, the at least one user data and the at least one dish data using at least one machine learning model. Further, the method may include determining, using the processing device, a presence of at least one allergen associated with the at least one user in the at least one dish based on the analyzing. Further, the at least one allergen may be at least one of one or more ingredients used for preparing the at least one dish. Further, the at least one allergen specifically produces at least one allergic reaction in the at least one user. Further, the method may include determining, using the processing device, a removability of the at least one allergen from the at least one dish based on the determining of the presence of the at least one allergen and the analyzing. Further, the method may include generating, using the processing device, a label for each of the at least one dish based on the determining of the presence of the at least one allergen and the determining of the removability of the at least one allergen. Further, the method may include generating, using the processing device, a menu for the at least one user based on the label and each of the at least one dish data of each of the at least one dish. Further, the menu may include a dish indication of each of the at least one dish and the label associated with the dish indication. Further, the method may include transmitting, using the communication device, the menu to the at least one user device.

Further disclosed herein is a system for personalizing menus of restaurants based on a susceptibility of users to allergens, in accordance with some embodiments. Accordingly, the system may include a communication device configured for receiving at least one request from at least one user device associated with at least one user. Further, the communication device may be configured for transmitting a menu to the at least one user device. Further, the system may include a storage device communicatively coupled with the communication device. Further, the storage device may be configured for retrieving at least one user data associated with the at least one user based on the at least one request. Further, the storage device may be configured for retrieving at least one dish data of at least one dish associated with at least one restaurant based on the at least one request. Further, the at least one restaurant serves the at least one dish. Further, the system may include a processing device communicatively coupled with the storage device. Further, the processing device may be configured for analyzing the at least one user data and the at least one dish data using at least one machine learning model. Further, the processing device may be configured for determining a presence of at least one allergen associated with the at least one user in the at least one dish based on the analyzing. Further, the at least one allergen may be at least one of one or more ingredients used for preparing the at least one dish. Further, the at least one allergen specifically produces at least one allergic reaction in the at least one user. Further, the processing device may be configured for determining a removability of the at least one allergen from the at least one dish based on the determining of the presence of the at least one allergen and the analyzing. Further, the processing device may be configured for generating a label for each of the at least one dish based on the determining of the presence of the at least one allergen and the determining of the removability of the at least one allergen. Further, the processing device may be configured for generating the menu for the at least one user based on the label and each of the at least one dish data of each of the at least one dish. Further, the menu may include a dish indication of each of the at least one dish and the label associated with the dish indication.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flow chart of a method 200 for personalizing menus of restaurants based on a susceptibility of users to allergens, in accordance with some embodiments.

FIG. 3 is a flow chart of a method 300 for personalizing menus of restaurants based on a susceptibility of users to allergens, in accordance with some embodiments.

FIG. 4 is a flow chart of a method 400 for personalizing menus of restaurants based on a susceptibility of users to allergens, in accordance with some embodiments.

FIG. 5 is a flow chart of a method 500 for personalizing menus of restaurants based on a susceptibility of users to allergens, in accordance with some embodiments.

FIG. 6 is a flow chart of a method 600 for personalizing menus of restaurants based on a susceptibility of users to allergens, in accordance with some embodiments.

FIG. 7 is a block diagram of a system 700 for personalizing menus of restaurants based on a susceptibility of users to allergens, in accordance with some embodiments.

FIG. 8 is a block diagram of the system 700 for personalizing menus of restaurants based on a susceptibility of users to allergens, in accordance with some embodiments.

FIG. 9 illustrates a screenshot of a user interface 900 of a software platform associated with the disclosed system, in accordance with some embodiments.

FIG. 10 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for personalizing menus of restaurants based on a susceptibility of users to allergens, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smartphone, an Internet of Things (IOT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, iOS, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for personalizing menus of restaurants based on a susceptibility of users to allergens.

Further, the disclosed system may be configured to provide an allergen awareness feature that involves two fields in the restaurant management platform where restaurant owners may input the ingredients in each dish, including whether the ingredients are allergens or not and whether the ingredients that are allergens are removable or not. This information may be then stored in a database and may be used to display two badges (such as a label). A first badge indicates the presence of the ingredient that is the allergen. A second badge indicates whether or not the ingredient which is the allergen, may be removed. When a guest accesses the menu on the platform (web), they will have the option to input any allergies they are concerned about. Further, the disclosed system may search the database for the presence of these ingredients which are allergens and associated with the allergies, in the dishes and display a badge indicating whether or not the ingredients that are allergens can be removed. The two fields for “removable” and “not removable” ingredients may not be displayed to guests (such as users), but the information entered into these fields may be used to provide guests with important information about the ingredients in each dish and to help them make informed choices about what to order.

Further, the present disclosure describes an allergen awareness feature that may be a software solution for restaurant management platforms. The feature provides real-time information about the presence of ingredients that are allergens in dishes and displays a badge indicating whether or not the ingredient that is the allergen can be removed. Further, the allergen awareness feature may be a software solution that is designed to run on a computer, tablet, or smartphone with an internet connection. Further, the disclosed system may be implemented as part of a restaurant management platform and may provide a safe and convenient way for guests with food allergies or sensitivities to dine at restaurants.

Further, the allergen awareness feature requires a database to store the information about allergens in each dish and a user interface to allow the restaurant owners to input this information and guests to access the menu and input their allergens. The disclosed system may be configured to search the database and display a first badge indicating the presence of the ingredient that is the allergen and a second badge indicating whether or not it can be removed. Further, two fields in the restaurant management platform where the restaurant owners may input the ingredients in each dish, including whether the ingredients are allergens or not and whether the ingredients which are allergens are removable or not. Further, the disclosed system may include the database to store the information about ingredients that are allergens in each dish and a user interface to allow restaurant owners to input this information and guests to access the menu and input their allergies. Further, the disclosed system may search the database and display two badges, a first badge is for indicating the presence of the ingredient which is the allergen (or allergens) and a second badge is for indicating whether or not the ingredient which is the allergen is removable or not.

Further, the present disclosure describes a system of detecting allergens in dishes for facilitating personalizing menus of restaurants based on a susceptibility of users to the ingredients that are the allergens. Further, the disclosed system is primarily based on filtering through a database of ingredients and their respective groups (such as dairy products, which include milk and its derivatives) for identifying the ingredients that are the allergens present in a dish.

Further, the disclosed system may perform translation of inputs (such as information on allergens that specifically affects a user) provided by a user in a user's language into a standard language. Further, the disclosed system may allow the user to choose to view the menu of the restaurant in the user's language. Further, the disclosed system may then translate all ingredients from the standard language into the user's language and display the dishes containing the specified allergens in the user's language.

Further, the present disclosure describes a system of detecting allergens in dishes for facilitating personalizing menus of restaurants based on a susceptibility of users to the allergens. Further, the disclosed system allows admins to add a new dish. Further, when admins add a new dish, the disclosed system provides the standard fields along with the fields associated with the “Allergy Awareness Feature” (AAF), which includes two fields for removable and non-removable ingredients. Each ingredient can have sub-ingredients (like sauces), and the disclosed system provides an extra pop-up window for those also. Once all ingredients are entered and saved, the disclosed system analyzes ingredients by comparing the ingredients to an allergy database, identifying allergen groups like dairy, nuts, etc., for the ingredients. Afterward, the disclosed system connects to a translation service and translates ingredients, sub-ingredients, and allergen groups into preferred languages. For users-guests, they can visit the restaurant site's settings and input their allergies (one or few) or allergen groups in their preferred language. The disclosed system checks each ingredient or group against the database and assigns one of two badges to the dish, the first badge may be Contains allergen-non-removable and the second badge may be Allergen present removable on request.

Further, the present disclosure describes a system of detecting allergens in dishes for facilitating personalizing menus of restaurants based on a susceptibility of users to the allergens. Further, the disclosed system assures food safety of the dishes requested by the user from restaurants, addresses the dietary concerns of the user regarding the dishes, provides information on ingredients that are allergens present in dishes, enables ingredient tracking of the ingredients of the dishes, improves menu accessibility of the menu of the restaurants by personalizing menus of restaurants based on a susceptibility of users to the allergens.

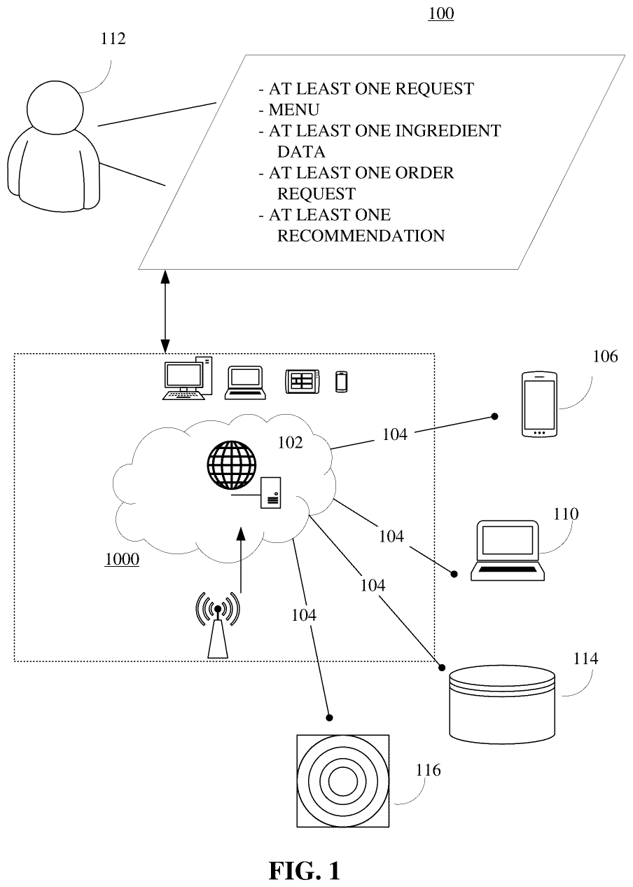

FIG. 1 is an illustration of an online platform 100 consistent with various embodiments of the present disclosure. By way of non-limiting example, the online platform 100 for personalizing menus of restaurants based on a susceptibility of users to allergens may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1000.

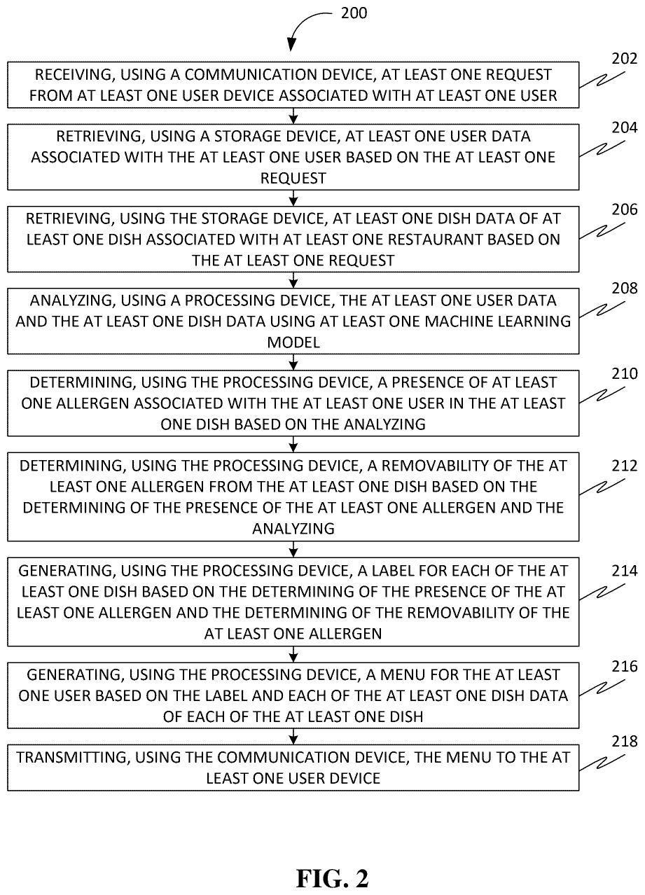

FIG. 2 is a flow chart of a method 200 for personalizing menus of restaurants based on a susceptibility of users to allergens, in accordance with some embodiments. Accordingly, at 202, the method 200 may include receiving, using a communication device (such as a communication device 702), at least one request from at least one user device (such as at least one user device 802) associated with at least one user. Further, the at least one request may include a request to access a menu of at least one restaurant. Further, the at least one user may order the at least one dish from the at least one restaurant by accessing the menu. Further, the at least one user device may include a computing device, a client device, etc. Further, the at least one user may be an individual. Further, the at least one user device may be configured for generating the at least one request based on receiving at least one input from the at least one user. Further, in an embodiment, the at least one request may include at least one user identifier associated with the at least one user and at least one dish identifier associated with the at least one dish. Further, in an embodiment, the at least one user device may include at least one sensor (such as a location sensor, a biological sensor, etc.). Further, the at least one sensor may be configured for generating the at least one request based on detecting at least one characteristic associated with the at least one user. Further, the at least one characteristic may include a user's location, a user's biological state (presence of specific antibodies, proteins, etc., in a body of the at least one user), etc.

Further, at 204, the method 200 may include retrieving, using a storage device (such as a storage device 706), at least one user data associated with the at least one user based on the at least one request. Further, the at least one user data may include information on allergens that the at least one user may be susceptible towards. Further, the retrieving of the at least one user data may be based on the at least one user identifier.

Further, at 206, the method 200 may include retrieving, using the storage device, at least one dish data of at least one dish associated with at least one restaurant based on the at least one request. Further, the at least one restaurant serves the at least one dish. Further, the at least one dish data may include information on the at least one dish served by the at least one restaurant. Further, the at least one dish data may include information on ingredients used for preparing the at least one dish and a food group (such as milk, eggs, fish, Crustacean shellfish, tree nuts, peanuts, wheat, and soybeans) of the ingredients. Further, the at least one dish data may include information on allergens present in the at least one dish that may potentially cause allergic reactions in the at least one user consuming the at least one dish.

Further, at 208, the method 200 may include analyzing, using a processing device (such as a processing device 704), the at least one user data and the at least one dish data using at least one machine learning model. Further, in an embodiment, the at least one machine learning model may be trained for creating a mapping of allergens that the at least one user may be susceptible to and allergens present in the at least one dish that may potentially cause allergic reactions in the at least one user consuming the at least one dish by detecting a commonality between the allergens that the at least one user may be susceptible to and the allergens present in the at least one dish that may potentially cause the allergic reactions. Further, the commonality may include a compositional commonality between the allergens that the at least one user may be susceptible to and the allergens present in the at least one dish that may potentially cause the allergic reactions. Further, the compositional commonality corresponds to a similar composition of allergens. Further, the commonality may include a functional commonality between the allergens that the at least one user may be susceptible to and the allergens present in the at least one dish that may potentially cause the allergic reactions. Further, the functional commonality corresponds to similar functions of allergens for producing the allergic reactions in the at least one user. Further, in an embodiment, the at least one machine learning model may be trained for identifying the allergens present in the at least one dish that may potentially cause allergic reactions in the at least one user consuming the at least one dish by accessing a database comprising allergens corresponding to the ingredients and the food group of the ingredients of the at least one dish and creating a mapping of allergens that the at least one user may be susceptible to and allergens present in the at least one dish that may potentially cause allergic reactions in the at least one user consuming the at least one dish by detecting a commonality between the allergens that the at least one user may be susceptible to and the allergens present in the at least one dish that may potentially cause the allergic reactions in the at least one user.

Further, at 210, the method 200 may include determining, using the processing device, a presence of at least one allergen associated with the at least one user in the at least one dish based on the analyzing. Further, the at least one allergen may be at least one of one or more ingredients used for preparing the at least one dish. Further, the at least one allergen may be comprised in at least one of one or more ingredients used for preparing the at least one dish. Further, the at least one allergen specifically produces at least one allergic reaction in the at least one user. Further, the determining of the presence of the at least one allergen may be based on the mapping of the allergens that the at least one user may be susceptible to and the allergens that may potentially cause the allergic reactions in the at least one user consuming the at least one dish.

Further, at 212, the method 200 may include determining, using the processing device, a removability of the at least one allergen from the at least one dish based on the determining of the presence of the at least one allergen and the analyzing.

Further, at 214, the method 200 may include generating, using the processing device, a label (such as a badge) for each of the at least one dish based on the determining of the presence of the at least one allergen and the determining of the removability of the at least one allergen. Further, the label indicates the presence of the at least one allergen and the removability of the at least one allergen from the at least one dish.

Further, at 216, the method 200 may include generating, using the processing device, a menu for the at least one user based on the label and each of the at least one dish data of each of the at least one dish. Further, the menu may include a dish indication of each of the at least one dish and the label associated with the dish indication.

Further, at 218, the method 200 may include transmitting, using the communication device, the menu to the at least one user device. Further, the menu may be a dynamic menu that dynamically changes based on the at least one characteristic of the at least one user accessing the menu. Further, the dish indication may include a dish identifier of the at least one dish, ingredients present in the at least one dish, etc. Further, the generating of the menu may include generating the menu in real time.

Further, in some embodiments, the presence of the at least one allergen may include a positive presence of the at least one allergen and a negative presence of the at least one allergen. Further, the at least one dish may include the at least one allergen in the positive presence. Further, the at least one dish may not include the at least one allergen in the negative presence.

Further, in some embodiments, the removability of the at least one allergen may include a positive removability of the at least one allergen and a negative removability of the at least one allergen. Further, the at least one allergen may be removable from the at least one dish in the positive removability of the at least one allergen. Further, the at least one allergen may be not removable from the at least one dish in the negative removability of the at least one allergen.

Further, in some embodiments, the label may include a removable allergen label and a non-removable allergen label. Further, the removable allergen label indicates the positive removability of the at least one allergen from the at least one dish. Further, the non-removable allergen label indicates the negative removability of the at least one allergen from the at least one dish.

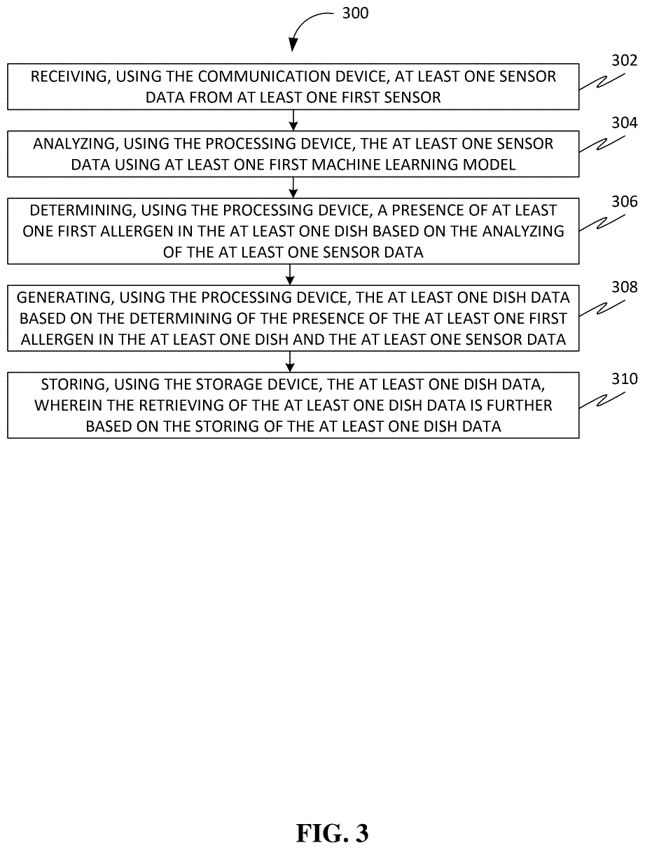

FIG. 3 is a flow chart of a method 300 for personalizing menus of restaurants based on a susceptibility of users to allergens, in accordance with some embodiments. Accordingly, at 302, the method 300 may include receiving, using the communication device, at least one sensor data from at least one sensor (such as at least one sensor 804). Further, the at least one sensor may be configured for generating the at least one sensor data based on detecting at least one characteristic of the at least one dish. Further, the at least one sensor may include a visible light camera, an infrared camera, a hyperspectral camera, a chemical sensor, a biosensor (such as an optical biosensor, an electromechanical biosensor, and an electrochemical biosensor), etc. Further, the at least one characteristic may include color, enzymes, absorption, fluorescence, surface-plasmon resonance (SPR), carbohydrates, alcohols, acids, proteins, peptides, DNA, etc., associated with the at least one dish.

Further, at 304, the method 300 may include analyzing, using the processing device, the at least one sensor data using at least one first machine learning model. Further, in an embodiment, the at least one first machine learning model may be trained for detecting markers of the allergens present in the at least one dish based on characteristics of the at least one dish. Further, the markers correspond to the characteristics. Further, in an embodiment, the at least one first machine learning model may be trained for detecting a food group of the ingredients of the at least one dish.

Further, at 306, the method 300 may include determining, using the processing device, a presence of at least one first allergen in the at least one dish based on the analyzing of the at least one sensor data. Further, the at least one first allergen may be at least one of one or more ingredients used for preparing the at least one dish. Further, the at least one first allergen does not specifically produces the at least one allergic reaction in the at least one user. Further, the at least one first allergen may include the allergens present in the at least one dish that may potentially cause allergic reactions in the at least one user consuming the at least one dish. Further, the determining of the presence of the at least one first allergen in the at least one dish may be based on the markers of the allergen. Further, the determining of the presence of the at least one first allergen in the at least one dish may be based on the food group of the ingredients of the at least one dish.

Further, at 308, the method 300 may include generating, using the processing device, the at least one dish data based on the determining of the presence of the at least one first allergen in the at least one dish and the at least one sensor data.

Further, at 310, the method 300 may include storing, using the storage device, the at least one dish data. Further, the retrieving of the at least one dish data may be based on the storing of the at least one dish data.

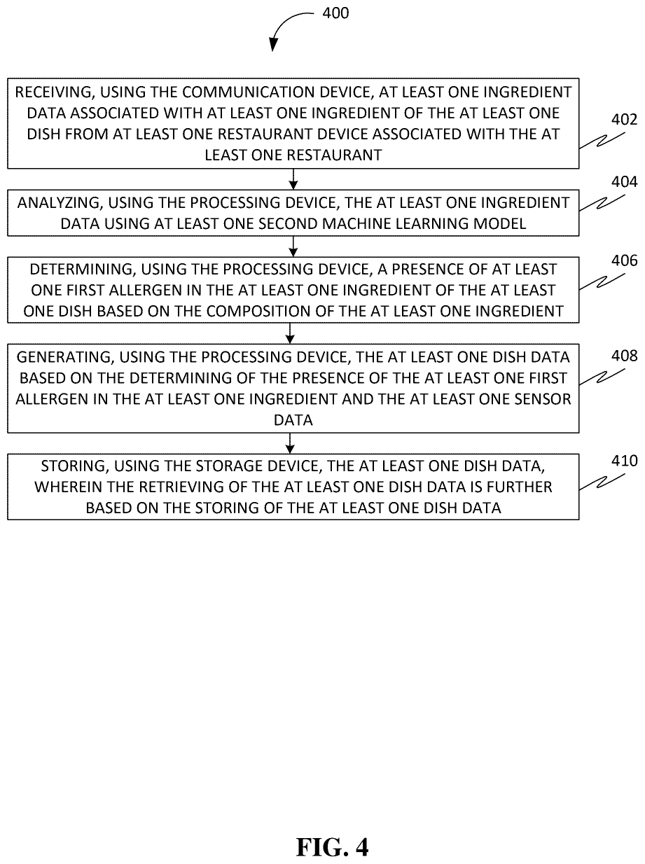

FIG. 4 is a flow chart of a method 400 for personalizing menus of restaurants based on a susceptibility of users to allergens, in accordance with some embodiments. Accordingly, at 402, the method 400 may include receiving, using the communication device, at least one ingredient data associated with at least one ingredient of the at least one dish from at least one restaurant device (such as at least one restaurant device 806) associated with the at least one restaurant. Further, the at least one restaurant device may be a computing device, a client device, etc. Further, at 404, the method 400 may include analyzing, using the processing device, the at least one ingredient data using at least one second machine learning model.

Further, the at least one second machine learning model may be configured for detecting a composition of the at least one ingredient based on the at least one ingredient data. Further, in an embodiment, the at least one second machine learning model may be trained for identifying allergens present in the at least one dish that may potentially cause allergic reactions in the at least one user consuming the at least one dish by accessing a database comprising allergens corresponding to the composition of the at least one ingredient and creating a mapping of allergens that the at least one user may be susceptible to and allergens present in the at least one dish that may potentially cause allergic reactions in the at least one user consuming the at least one dish by detecting a commonality between the allergens that the at least one user may be susceptible to and the allergens present in the at least one dish that may potentially cause the allergic reactions. Further, at 406, the method 400 may include determining, using the processing device, a presence of at least one first allergen in the at least one ingredient of the at least one dish based on the composition of the at least one ingredient. Further, the at least one first allergen may be at least one of one or more ingredients used for preparing the at least one dish. Further, the at least one first allergen may be the allergens present in the at least one dish that may potentially cause allergic reactions in the at least one user consuming the at least one dish. Further, the at least one first allergen does not specifically produces the at least one allergic reaction in the at least one user.

Further, at 408, the method 400 may include generating, using the processing device, the at least one dish data based on the determining of the presence of the at least one first allergen in the at least one ingredient and the at least one sensor data. Further, at 410, the method 400 may include storing, using the storage device, the at least one dish data. Further, the retrieving of the at least one dish data may be based on the storing of the at least one dish data.

Further, in some embodiments, the at least one ingredient data may include at least one first ingredient and at least one second ingredient of the at least one dish. Further, the at least one first ingredient may be optional for preparing the at least one dish and the at least one second ingredient may be necessary for preparing the at least one dish. Further, the at least one first ingredient may be removable from the at least one dish and the at least one second ingredient may be not removable from the at least one dish.

Further, the method 400 may include determining, using the processing device, an association of each of the at least one allergen with at least one of the at least one first ingredient and the at least one second ingredient of the at least one dish based on the determining of the presence of the at least one allergen associated with the at least one user in the at least one dish and the determining of the presence of the at least one first allergen in the at least one ingredient of the at least one dish. Further, the association may include a commonality between the at least one allergen and the at least one first allergen. Further, the at least one allergen may be allergens present in the at least one dish that may specifically cause the allergic reactions to the at least one user consuming the at least one dish and the at least one first allergen may be allergens present in the at least one dish that may potentially cause the allergic reactions in at least one user consuming the at least one dish. Further, the determining of the removability of the at least one allergen from the at least one dish may be further based on the association of each of the at least one allergen with at least one of the at least one first ingredient and the at least one second ingredient of the at least one dish.

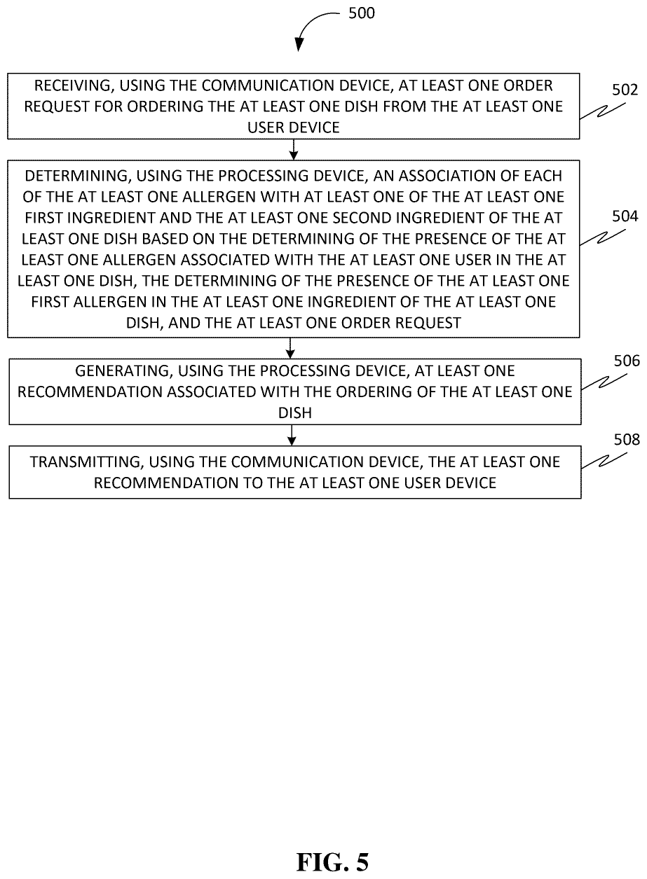

FIG. 5 is a flow chart of a method 500 for personalizing menus of restaurants based on a susceptibility of users to allergens, in accordance with some embodiments. Further, at 502, the method 500 may include receiving, using the communication device, at least one order request for ordering the at least one dish from the at least one user device. Further, at 504, the method 500 may include determining, using the processing device, an association of each of the at least one allergen with at least one of the at least one first ingredient and the at least one second ingredient of the at least one dish based on the determining of the presence of the at least one allergen associated with the at least one user in the at least one dish, the determining of the presence of the at least one first allergen in the at least one ingredient of the at least one dish, and the at least one order request. Further, at 506, the method 500 may include generating, using the processing device, at least one recommendation associated with the ordering of the at least one dish. Further, at 508, the method 500 may include transmitting, using the communication device, the at least one recommendation to the at least one user device.

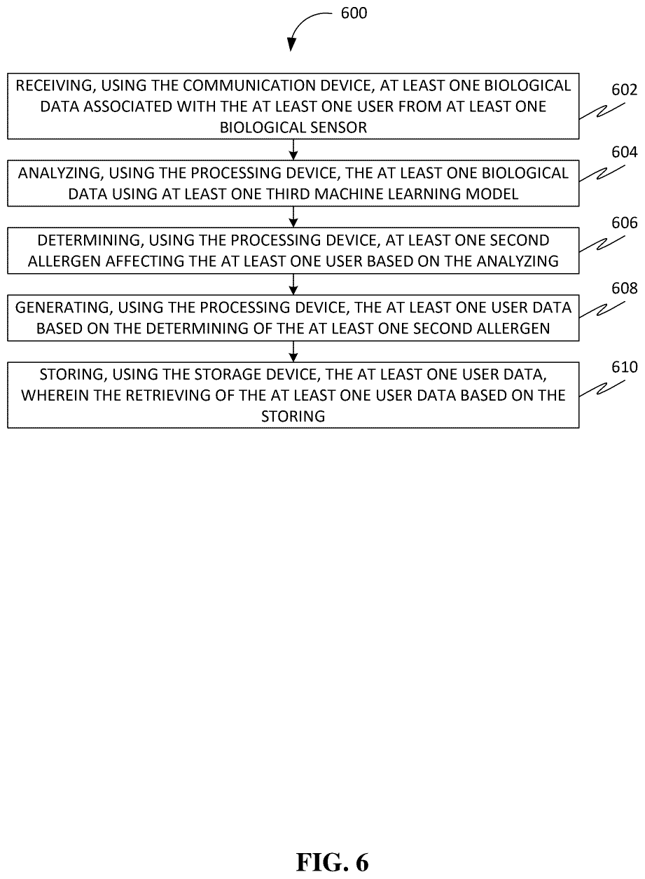

FIG. 6 is a flow chart of a method 600 for personalizing menus of restaurants based on a susceptibility of users to allergens, in accordance with some embodiments. Further, at 602, the method 600 may include receiving, using the communication device, at least one biological data associated with the at least one user from at least one biological sensor (such as at least one biological sensor 808). Further, the at least one biological sensor may be configured for generating the at least one biological data based on detecting a presence and a level of one or more hormones, a presence and a level of one or more enzymes, a presence and an amount of one or more antibodies, etc., in a body of the at least one user. Further, at 604, the method 600 may include analyzing, using the processing device, the at least one biological data using at least one third machine learning model. Further, the at least one third machine learning model may be trained for determining the susceptibility of the at least one user to allergens based on the at least one biological data. Further, at 606, the method 600 may include determining, using the processing device, at least one second allergen affecting the at least one user based on the analyzing. Further, the at least one second allergen may be at least one of one or more ingredients used for preparing the at least one dish. Further, the determining of the at least one second allergen affecting the at least one user may be based on the susceptibility of the at least one user to the allergens. Further, the at least one second allergen may be allergens that specifically affect the at least one user by producing allergic reactions in the at least one user. Further, at 608, the method 600 may include generating, using the processing device, the at least one user data based on the determining of the at least one second allergen. Further, at 610, the method 600 may include storing, using the storage device, the at least one user data. Further, the retrieving of the at least one user data based on the storing.

Further, in some embodiments, the at least one dish data may include a presence of at least one first allergen in at least one ingredient of the at least one dish. Further, the at least one first allergen may be at least one of one or more ingredients used for preparing the at least one dish. Further, the at least one user data may include at least one second allergen affecting the at least one user. Further, the at least one second allergen may be at least one of one or more ingredients used for preparing the at least one dish. Further, the analyzing may include comparing the at least one first allergen and the at least one second allergen. Further, the comparing may include identifying a commonality between the at least one first allergen and the at least one second allergen using the at least one machine learning model. Further, the determining of the presence of the at least one allergen associated with the at least one user in the at least one dish may be based on the comparing.

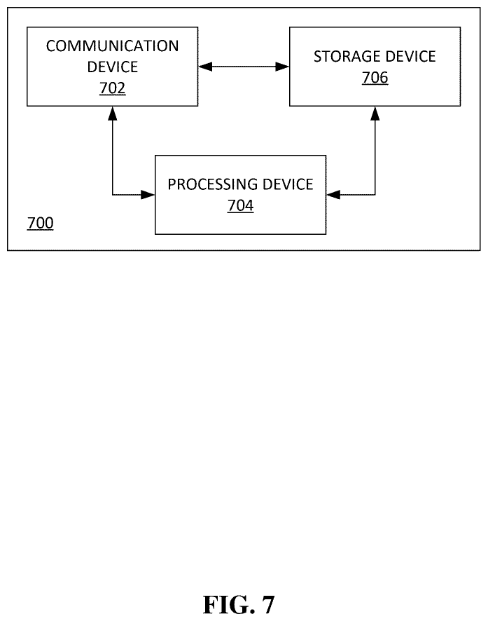

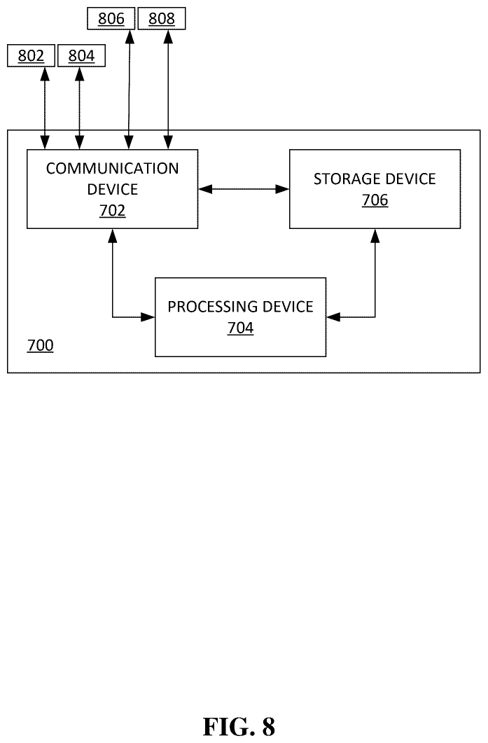

FIG. 7 is a block diagram of a system 700 for personalizing menus of restaurants based on a susceptibility of users to allergens, in accordance with some embodiments. Accordingly, the system 700 may include a communication device 702 configured for receiving at least one request from at least one user device 802 (as shown in FIG. 8) associated with at least one user. Further, the communication device 702 may be configured for transmitting a menu to the at least one user device 802. Further, the system 700 may include a storage device 706 communicatively coupled with the communication device 702. Further, the storage device 706 may be configured for retrieving at least one user data associated with the at least one user based on the at least one request. Further, the storage device 706 may be configured for retrieving at least one dish data of at least one dish associated with at least one restaurant based on the at least one request. Further, the at least one restaurant serves the at least one dish.

Further, the system 700 may include a processing device 704 communicatively coupled with the storage device 706. Further, the processing device 704 may be configured for analyzing the at least one user data and the at least one dish data using at least one machine learning model. Further, the processing device 704 may be configured for determining a presence of at least one allergen associated with the at least one user in the at least one dish based on the analyzing. Further, the at least one allergen may be at least one of one or more ingredients used for preparing the at least one dish. Further, the at least one allergen specifically produces at least one allergic reaction in the at least one user. Further, the processing device 704 may be configured for determining a removability of the at least one allergen from the at least one dish based on the determining of the presence of the at least one allergen and the analyzing. Further, the processing device 704 may be configured for generating a label for each of the at least one dish based on the determining of the presence of the at least one allergen and the determining of the removability of the at least one allergen. Further, the processing device 704 may be configured for generating the menu for the at least one user based on the label and each of the at least one dish data of each of the at least one dish. Further, the menu may include a dish indication of each of the at least one dish and the label associated with the dish indication.

Further, in some embodiments, the presence of the at least one allergen may include a positive presence of the at least one allergen and a negative presence of the at least one allergen. Further, the at least one dish may include the at least one allergen in the positive presence. Further, the at least one dish does not include the at least one allergen in the negative presence.

Further, in some embodiments, the removability of the at least one allergen may include a positive removability of the at least one allergen and a negative removability of the at least one allergen. Further, the at least one allergen may be removable from the at least one dish in the positive removability of the at least one allergen. Further, the at least one allergen may be not removable from the at least one dish in the negative removability of the at least one allergen.

Further, in some embodiments, the label may include a removable allergen label and a non-removable allergen label. Further, the removable allergen label indicates the positive removability of the at least one allergen from the at least one dish. Further, the non-removable allergen label indicates the negative removability of the at least one allergen from the at least one dish.

Further, in some embodiments, the communication device 702 may be configured for receiving at least one sensor data from at least one sensor 804 (as shown in FIG. 8). Further, the at least one sensor 804 may be configured for generating the at least one sensor data based on detecting at least one characteristic of the at least one dish. Further, the processing device 704 may be configured for analyzing the at least one sensor data using at least one first machine learning model. Further, the processing device 704 may be configured for determining a presence of at least one first allergen in the at least one dish based on the analyzing of the at least one sensor data. Further, the at least one first allergen may be at least one of one or more ingredients used for preparing the at least one dish. Further, the at least one first allergen does not specifically produces the at least one allergic reaction in the at least one user. Further, the processing device 704 may be configured for generating the at least one dish data based on the determining of the presence of the at least one first allergen in the at least one dish and the at least one sensor data. Further, the storage device 706 may be configured for storing the at least one dish data. Further, the retrieving of the at least one dish data may be based on the storing of the at least one dish data.

Further, in some embodiments, the communication device 702 may be configured for receiving at least one ingredient data associated with at least one ingredient of the at least one dish from at least one restaurant device 806 (as shown in FIG. 8) associated with the at least one restaurant. Further, the processing device 704 may be configured for analyzing the at least one ingredient data using at least one second machine learning model. Further, the at least one second machine learning model may be configured for detecting a composition of the at least one ingredient based on the at least one ingredient data. Further, the processing device 704 may be configured for determining a presence of at least one first allergen in the at least one ingredient of the at least one dish based on the composition of the at least one ingredient. Further, the at least one first allergen may be at least one of one or more ingredients used for preparing the at least one dish. Further, the at least one first allergen does not specifically produces the at least one allergic reaction in the at least one user. Further, the processing device 704 may be configured for generating the at least one dish data based on the determining of the presence of the at least one first allergen in the at least one ingredient and the at least one sensor data. Further, the storage device 706 may be configured for storing the at least one dish data. Further, the retrieving of the at least one dish data may be based on the storing of the at least one dish data.

Further, in some embodiments, the at least one ingredient data may include at least one first ingredient and at least one second ingredient of the at least one dish. Further, the at least one first ingredient may be optional for preparing the at least one dish and the at least one second ingredient may be necessary for preparing the at least one dish. Further, the at least one first ingredient may be removable from the at least one dish and the at least one second ingredient may be not removable from the at least one dish.

Further, in an embodiment, the processing device 704 may be configured for determining an association of each of the at least one allergen with at least one of the at least one first ingredient and the at least one second ingredient of the at least one dish based on the determining of the presence of the at least one allergen associated with the at least one user in the at least one dish and the determining of the presence of the at least one first allergen in the at least one ingredient of the at least one dish.

Further, in some embodiments, the communication device 702 may be configured for receiving at least one order request for ordering the at least one dish from the at least one user device 802. Further, the communication device 702 may be configured for transmitting at least one recommendation to the at least one user device 802. Further, the processing device 704 may be configured for determining an association of each of the at least one allergen with at least one of the at least one first ingredient and the at least one second ingredient of the at least one dish based on the determining of the presence of the at least one allergen associated with the at least one user in the at least one dish, the determining of the presence of the at least one first allergen in the at least one ingredient of the at least one dish, and the at least one order request. Further, the processing device 704 may be configured for generating the at least one recommendation associated with the ordering of the at least one dish.

Further, in some embodiments, the communication device 702 may be configured for receiving at least one biological data associated with the at least one user from at least one biological sensor 808 (as shown in FIG. 8). Further, the processing device 704 may be configured for analyzing the at least one biological data using at least one third machine learning model. Further, the processing device 704 may be configured for determining at least one second allergen affecting the at least one user based on the analyzing. Further, the at least one second allergen may be at least one of one or more ingredients used for preparing the at least one dish. Further, the processing device 704 may be configured for generating the at least one user data based on the determining of the at least one second allergen. Further, the storage device 706 may be configured for storing the at least one user data. Further, the retrieving of the at least one user data based on the storing.

Further, in some embodiments, the at least one dish data may include a presence of at least one first allergen in at least one ingredient of the at least one dish. Further, the at least one first allergen may be at least one of one or more ingredients used for preparing the at least one dish. Further, the at least one user data may include at least one second allergen affecting the at least one user. Further, the at least one second allergen may be at least one of one or more ingredients used for preparing the at least one dish. Further, the analyzing may include comparing the at least one first allergen and the at least one second allergen. Further, the determining of the presence of the at least one allergen associated with the at least one user in the at least one dish may be based on the comparing.

Further, in an embodiment, the system 700 may include the at least one user device 802, the at least one sensor 804, the at least one restaurant device 806, and the at least one biological sensor 808. Further, the processing device 704 may be communicatively coupled with the at least one user device 802, the at least one sensor 804, the at least one restaurant device 806, and the at least one biological sensor 808.

FIG. 8 is a block diagram of the system 700 for personalizing menus of restaurants based on a susceptibility of users to allergens, in accordance with some embodiments.

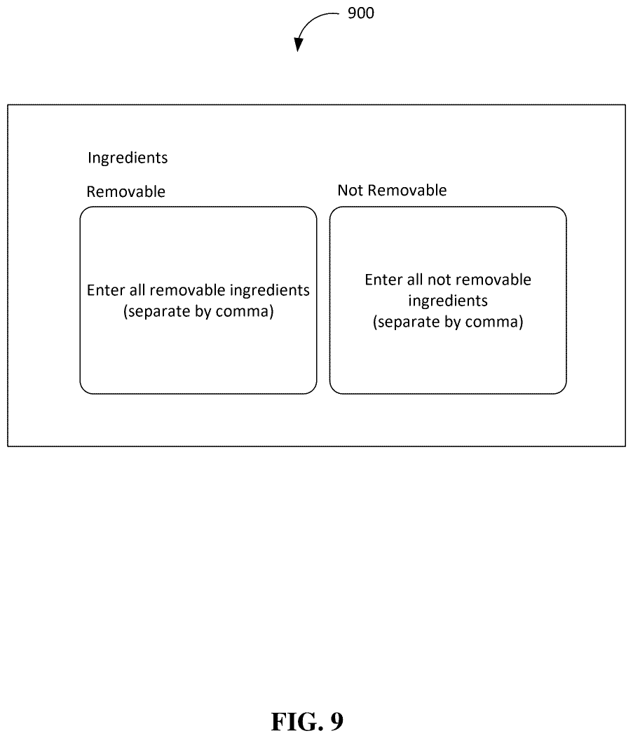

FIG. 9 illustrates a screenshot of a user interface 900 of a software platform associated with the disclosed system, in accordance with some embodiments. Further, the user interface 900 allows at least one entity (chefs, managers, restaurant owners, administrators, etc.) associated with the at least one restaurant to enter ingredients in two separate boxes. Further, a first box may be specified for entering ingredients of a dish that may be removable from the dish. Further, a second box may be specified for entering ingredients of the dish that may be non removable from the dish.

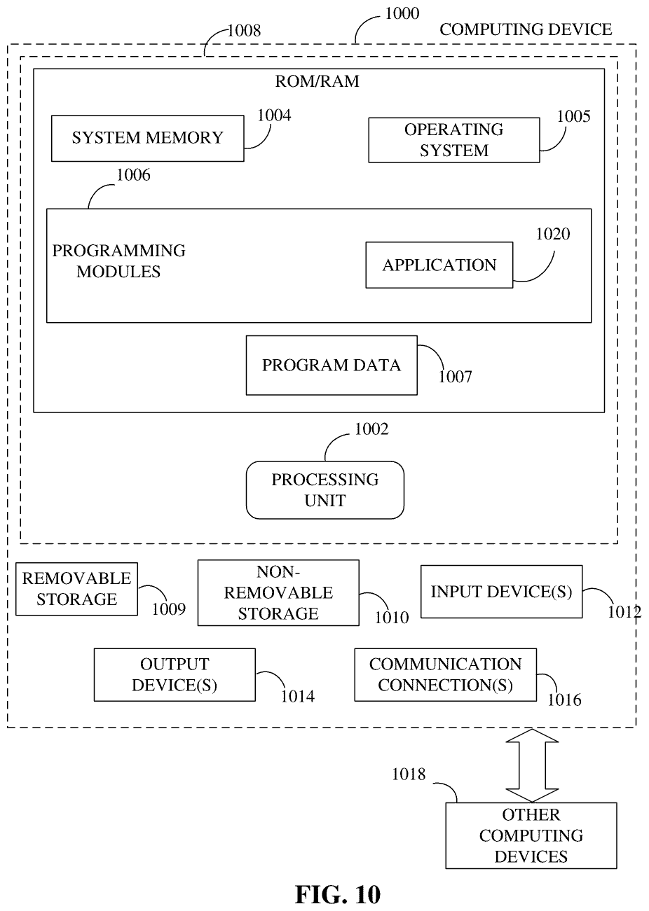

With reference to FIG. 10, a system consistent with an embodiment of the disclosure may include a computing device or cloud service, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination.

System memory 1004 may include operating system 1005, one or more programming modules 1006, and may include a program data 1007. Operating system 1005, for example, may be suitable for controlling computing device 1000's operation. In one embodiment, programming modules 1006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and non-volatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A method for personalizing menus of restaurants based on a susceptibility of users to allergens, the method comprising:
receiving, using a communication device, at least one request from at least one user device associated with at least one user;
retrieving, using a storage device, at least one user data associated with the at least one user based on the at least one request;
retrieving, using the storage device, at least one dish data of at least one dish associated with at least one restaurant based on the at least one request, wherein the at least one restaurant serves the at least one dish;
analyzing, using a processing device, the at least one user data and the at least one dish data using at least one machine learning model;
determining, using the processing device, a presence of at least one allergen associated with the at least one user in the at least one dish based on the analyzing, wherein the at least one allergen specifically produces at least one allergic reaction in the at least one user;
determining, using the processing device, a removability of the at least one allergen from the at least one dish based on the determining of the presence of the at least one allergen and the analyzing;
generating, using the processing device, a label for each of the at least one dish based on the determining of the presence of the at least one allergen and the determining of the removability of the at least one allergen;
generating, using the processing device, a menu for the at least one user based on the label and each of the at least one dish data of each of the at least one dish, wherein the menu comprises a dish indication of each of the at least one dish and the label associated with the dish indication; and
transmitting, using the communication device, the menu to the at least one user device.

2. The method of claim 1, wherein the presence of the at least one allergen comprises a positive presence of the at least one allergen and a negative presence of the at least one allergen, wherein the at least one dish comprises the at least one allergen in the positive presence, wherein the at least one dish does not comprises the at least one allergen in the negative presence.

3. The method of claim 2, wherein the removability of the at least one allergen comprises a positive removability of the at least one allergen and a negative removability of the at least one allergen, wherein the at least one allergen is removable from the at least one dish in the positive removability of the at least one allergen, wherein the at least one allergen is not removable from the at least one dish in the negative removability of the at least one allergen.

4. The method of claim 3, wherein the label comprises a removable allergen label and a non-removable allergen label, wherein the removable allergen label indicates the positive removability of the at least one allergen from the at least one dish, wherein the non-removable allergen label indicates the negative removability of the at least one allergen from the at least one dish.

5. The method of claim 1 further comprising:
receiving, using the communication device, at least one sensor data from at least one sensor, wherein the at least one sensor is configured for generating the at least one sensor data based on detecting at least one characteristic of the at least one dish;
analyzing, using the processing device, the at least one sensor data using at least one first machine learning model;
determining, using the processing device, a presence of at least one first allergen in the at least one dish based on the analyzing of the at least one sensor data, wherein the at least one first allergen does not specifically produces the at least one allergic reaction in the at least one user;
generating, using the processing device, the at least one dish data based on the determining of the presence of the at least one first allergen in the at least one dish and the at least one sensor data; and
storing, using the storage device, the at least one dish data, wherein the retrieving of the at least one dish data is further based on the storing of the at least one dish data.

6. The method of claim 1 further comprising:
receiving, using the communication device, at least one ingredient data associated with at least one ingredient of the at least one dish from at least one restaurant device associated with the at least one restaurant;
analyzing, using the processing device, the at least one ingredient data using at least one second machine learning model, wherein the at least one second machine learning model is configured for detecting a composition of the at least one ingredient based on the at least one ingredient data;
determining, using the processing device, a presence of at least one first allergen in the at least one ingredient of the at least one dish based on the composition of the at least one ingredient, wherein the at least one first allergen does not specifically produces the at least one allergic reaction in the at least one user;
generating, using the processing device, the at least one dish data based on the determining of the presence of the at least one first allergen in the at least one ingredient and the at least one sensor data; and
storing, using the storage device, the at least one dish data, wherein the retrieving of the at least one dish data is further based on the storing of the at least one dish data.

7. The method of claim 6, wherein the at least one ingredient data comprises at least one first ingredient and at least one second ingredient of the at least one dish, wherein the at least one first ingredient is optional for preparing the at least one dish and the at least one second ingredient is necessary for preparing the at least one dish, wherein the at least one first ingredient is removable from the at least one dish and the at least one second ingredient is not removable from the at least one dish.

8. The method of claim 7 further comprising determining, using the processing device, an association of each of the at least one allergen with at least one of the at least one first ingredient and the at least one second ingredient of the at least one dish based on the determining of the presence of the at least one allergen associated with the at least one user in the at least one dish and the determining of the presence of the at least one first allergen in the at least one ingredient of the at least one dish, wherein the determining of the removability of the at least one allergen from the at least one dish is further based on the association of each of the at least one allergen with at least one of the at least one first ingredient and the at least one second ingredient of the at least one dish.

9. The method of claim 1 further comprising:
receiving, using the communication device, at least one biological data associated with the at least one user from at least one biological sensor;
analyzing, using the processing device, the at least one biological data using at least one third machine learning model;
determining, using the processing device, at least one second allergen affecting the at least one user based on the analyzing;
generating, using the processing device, the at least one user data based on the determining of the at least one second allergen; and
storing, using the storage device, the at least one user data, wherein the retrieving of the at least one user data based on the storing.

10. The method of claim 1, wherein the at least one dish data comprises a presence of at least one first allergen in at least one ingredient of the at least one dish, wherein the at least one user data comprises at least one second allergen affecting the at least one user, wherein the analyzing comprises comparing the at least one first allergen and the at least one second allergen, wherein the determining of the presence of the at least one allergen associated with the at least one user in the at least one dish is further based on the comparing.

11. A system for personalizing menus of restaurants based on a susceptibility of users to allergens, the system comprising:
a communication device configured for:
receiving at least one request from at least one user device associated with at least one user; and
transmitting a menu to the at least one user device;
a storage device communicatively coupled with the communication device, wherein the storage device is configured for:
retrieving at least one user data associated with the at least one user based on the at least one request; and
retrieving at least one dish data of at least one dish associated with at least one restaurant based on the at least one request, wherein the at least one restaurant serves the at least one dish; and
a processing device communicatively coupled with the storage device, wherein the processing device is configured for:
analyzing the at least one user data and the at least one dish data using at least one machine learning model;
determining a presence of at least one allergen associated with the at least one user in the at least one dish based on the analyzing, wherein the at least one allergen specifically produces at least one allergic reaction in the at least one user;
determining a removability of the at least one allergen from the at least one dish based on the determining of the presence of the at least one allergen and the analyzing;
generating a label for each of the at least one dish based on the determining of the presence of the at least one allergen and the determining of the removability of the at least one allergen; and
generating the menu for the at least one user based on the label and each of the at least one dish data of each of the at least one dish, wherein the menu comprises a dish indication of each of the at least one dish and the label associated with the dish indication.

12. The system of claim 11, wherein the presence of the at least one allergen comprises a positive presence of the at least one allergen and a negative presence of the at least one allergen, wherein the at least one dish comprises the at least one allergen in the positive presence, wherein the at least one dish does not comprises the at least one allergen in the negative presence.

13. The system of claim 12, wherein the removability of the at least one allergen comprises a positive removability of the at least one allergen and a negative removability of the at least one allergen, wherein the at least one allergen is removable from the at least one dish in the positive removability of the at least one allergen, wherein the at least one allergen is not removable from the at least one dish in the negative removability of the at least one allergen.

14. The system of claim 13, wherein the label comprises a removable allergen label and a non-removable allergen label, wherein the removable allergen label indicates the positive removability of the at least one allergen from the at least one dish, wherein the non-removable allergen label indicates the negative removability of the at least one allergen from the at least one dish.

15. The system of claim 11, wherein the communication device is further configured for receiving at least one sensor data from at least one sensor, wherein the at least one sensor is configured for generating the at least one sensor data based on detecting at least one characteristic of the at least one dish, wherein the processing device is further configured for:
analyzing the at least one sensor data using at least one first machine learning model;
determining a presence of at least one first allergen in the at least one dish based on the analyzing of the at least one sensor data, wherein the at least one first allergen does not specifically produces the at least one allergic reaction in the at least one user; and
generating the at least one dish data based on the determining of the presence of the at least one first allergen in the at least one dish and the at least one sensor data, wherein the storage device is further configured for storing the at least one dish data, wherein the retrieving of the at least one dish data is further based on the storing of the at least one dish data.

16. The system of claim 11, wherein the communication device is further configured for receiving at least one ingredient data associated with at least one ingredient of the at least one dish from at least one restaurant device associated with the at least one restaurant, wherein the processing device is further configured for:
analyzing the at least one ingredient data using at least one second machine learning model, wherein the at least one second machine learning model is configured for detecting a composition of the at least one ingredient based on the at least one ingredient data;
determining a presence of at least one first allergen in the at least one ingredient of the at least one dish based on the composition of the at least one ingredient, wherein the at least one first allergen does not specifically produces the at least one allergic reaction in the at least one user; and
generating the at least one dish data based on the determining of the presence of the at least one first allergen in the at least one ingredient and the at least one sensor data, wherein the storage device is further configured for storing the at least one dish data, wherein the retrieving of the at least one dish data is further based on the storing of the at least one dish data.

17. The system of claim 16, wherein the at least one ingredient data comprises at least one first ingredient and at least one second ingredient of the at least one dish, wherein the at least one first ingredient is optional for preparing the at least one dish and the at least one second ingredient is necessary for preparing the at least one dish, wherein the at least one first ingredient is removable from the at least one dish and the at least one second ingredient is not removable from the at least one dish.

18. The system of claim 17, wherein the processing device is further configured for determining an association of each of the at least one allergen with at least one of the at least one first ingredient and the at least one second ingredient of the at least one dish based on the determining of the presence of the at least one allergen associated with the at least one user in the at least one dish and the determining of the presence of the at least one first allergen in the at least one ingredient of the at least one dish, wherein the determining of the removability of the at least one allergen from the at least one dish is further based on the association of each of the at least one allergen with at least one of the at least one first ingredient and the at least one second ingredient of the at least one dish.

19. The system of claim 11, wherein the communication device is further configured for receiving at least one biological data associated with the at least one user from at least one biological sensor, wherein the processing device is further configured for:
analyzing the at least one biological data using at least one third machine learning model;
determining at least one second allergen affecting the at least one user based on the analyzing; and
generating the at least one user data based on the determining of the at least one second allergen, wherein the storage device is further configured for storing the at least one user data, wherein the retrieving of the at least one user data based on the storing.

20. The system of claim 11, wherein the at least one dish data comprises a presence of at least one first allergen in at least one ingredient of the at least one dish, wherein the at least one user data comprises at least one second allergen affecting the at least one user, wherein the analyzing comprises comparing the at least one first allergen and the at least one second allergen, wherein the determining of the presence of the at least one allergen associated with the at least one user in the at least one dish is further based on the comparing.
